(19) United States
(12) Patent Application Publication
(10) Pub. No.: US 2026/0138879 A1
(43) Pub. Date: May 21, 2026

(54) MODIFIED LAYERED DOUBLE HYDROXIDE (LDH), PARTICLES COMPRISING SAID LDH, AND METHOD FOR PRODUCING SAID LDH

(71) Applicant: KISUMA CHEMICALS B.V., Veendam (NL)

(72) Inventors: Mathijs Adriaan Nanne Preenen, Veendam (NL); Wijnand Jacob Adrianus Van Der Laan, Veendam (NL); Chantal Mulder, Veendam (NL); Ceren Ozdilek, Veendam (NL); Tim Hauck, Veendam (NL); Daniel Wanders, Veendam (NL); Thijs Erik Leeuwerik, Veendam (NL)

(21) Appl. No.: 19/121,651

(22) PCT Filed: Oct. 18, 2023
(86) PCT No.: PCT/NL2023/050546

§ 371 Date: Apr. 16, 2025

(30) Foreign Application Priority Data
Oct. 18, 2022 (NL) 2033348

(51) Int. Cl. C01F 7/162

(52) U.S. Cl. CPC C01F 7/162; C01P 2002/72; C01P 2002/82; C01P 2002/88; C01P 2004/03; C01P 2004/61; C01P 2004/62

(57) ABSTRACT

The invention relates to a modified layered double hydroxide (LDH), particles comprising said modified LDH, a resin composition comprising a resin and said particles, a dispersion comprising a liquid and said particles, and a method for producing said modified LDH. The modified layered double hydroxide according to the invention comprises a modified layered double hydroxide according to formula (I), wherein: M₁ and M₂ are each independently a divalent metal selected from the group of Mg, Zn, Ca, Sr, Cu, Fe, Mn, Co, Ni, Sn, Pb, Cd, and Ba; in particular Mg, Zn, Cu, Fe, Mn, Co, Ni, and Cd; M₃ is trivalent metal such as Al and/or Fe; in particular Al; and Aⁿ⁻ is one or more of an intercalating n-valent anion, wherein m, x, y, and z are values in the ranges represented by: 0≤m<2 0<x≤0.5 0.5≤y+z≤1 further comprising a modified outer layer wherein the outer layer is modified with an organic acid derivative or salts thereof.

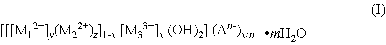

The present invention relates to a modified layered double hydroxide (LDH), particles comprising said modified LDH, a resin composition comprising a resin and said particles, a dispersion comprising a liquid and said particles, and a method for producing said modified LDH.

Conventional hydrotalcite particles have been developed for various uses including a thermal stabilizer for a polyvinyl chloride resin, a neutralizing agent for residues originating from using polyolefin polymerisation catalyst, an acid acceptor for a halogen-containing rubber, a heat-insulating agent for an agricultural film and the like. In addition, a suspension that comprises conventional hydrotalcite particles may be used as a liquid antacid or thermal stabiliser.

A problem with the conventional hydrotalcite particles used in polymer compositions is that said particles have a single functionality, such as an acid scavenger.

The present invention aims at obviating or at least reducing the aforementioned problem and to enable efficient and effective functionality of modified layered double hydroxide.

This objective is achieved with a modified layered double hydroxide (LDH) according to formula (I),

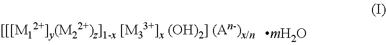

wherein:
M₁ and M₂ are each independently a divalent metal selected from the group of Mg, Zn, Ca, Sr, Cu, Fe, Mn, Co, Ni, Sn, Pb, Cd, and Ba; in particular Mg, Zn, Cu, Fe, Mn, Co, Ni, and Cd;
M₃ is trivalent metal such as Al and/or Fe; in particular Al; and
Aⁿ⁻ is one or more of an intercalating n-valent anion,
wherein m, x, y, and z are values in the ranges represented by:

$$0 \leq m < 2$$

$$0 < x \leq 0.5$$

$$0.5 \leq y + z \leq 1$$

further comprising a modified outer layer, wherein the outer layer is modified with an organic acid derivative or salts thereof.

It is noted that in this application a modified layered double hydroxide (LDH) refers to a substance having an exchangeable anion and H₂O as an interlayer, i.e. intermediate layer between the stacked hydroxide basic layers. It further relates to the use of modified LDH by taking advantage of its dual functionality of acid scavenger and nucleation. Thus, in a first aspect, the present invention provides a modified LDH, wherein the modified LDH comprises one or more intercalating n-valent anions, also referred to as an interlayer comprising a n-valent anion having a valence of n, and an outer layer which is modified with an organic acid derivative or salts thereof.

It is also noted that in a particular embodiment the functional groups of the modified outer layer of the modified LDH may be called carboxylic acid derivatives. Said derivatives may include carboxylic acids themselves, carboxylates (deprotonated carboxylic acids), amides, esters, thioesters, and acyl phosphates. Furthermore, the organic acid derivative may be represented by the salt of the corresponding organic acid derivative.

It is also noted that in an embodiment the modified LDH may comprises different metals selected from the groups of M₁, M₂, and M₃. In other words, multiple and different metals for each of M₁, M₂, and M₃ may be present in the modified LDH.

An advantage of the modified LDH according to the invention is that said LDH has a dual functionality. The dual functionality enables to reduce the resources (additives) during and/or after the synthesis of for example polymers. Preferably, the modified LDH and/or additives are provided to the polymers after the polymerisation. As a result, said synthesis may be performed in a more environmental friendly manner and more costs efficient. In particular, it was found that modifying the outer layer of the LDH with an organic acid derivative or salts thereof enables said dual functionality.

It is noted that throughout this application the synthesis of the polymer includes all stages of producing the end product/composition of the polymer. In other words, the synthesis includes the polymerisation of the desired polymer as well as the mixing, such as extrusion, of the polymer with the modified LDH and/or additives.

Said mixing may include mixing, preferably in the solid state, and/or dispersing of the polymer after the polymerisation with the modified LDH and/or additives. Optionally, the dispersing of said mixture may be performed in an extruder.

The modified LDH according to the invention enables to replace an acid scavenger as well as a nucleating agent in the synthesis of polymers. As a result, the complexity of additive feeding during the synthesis of a polymer is reduced. Furthermore, it was found that the modified LDH according to the invention provides cleaner polymers compared to polymer compositions with conventional acid scavengers and nucleating agents.

For example, replacement of migratory components, such as metallic soaps, may be enabled. As a result, specific migration limits (SML) and/or emissions of volatile organic compounds (VOC) are improved.

It was found that the modified LDH according to the invention may be efficiently and effectively used in the synthesis of polypropylene, polyethylene, and polystyrene. It is noted that polypropylene comprises homopolymers, (random and heterophasic) copolymers, and the like, and polyethylene comprises high-density polyethylene (HDPE), low-density polyethylene (LDPE), linear low-density polyethylene (LLDPE), and the like.

A further advantage of the modified LDH according to the invention is that said modified LDH is compatible with conventional (polymer) additives such as anti-oxidants, UV stabilizers, dispersing agents, and the like. Furthermore, the modified LDH according to the invention is also compatible with additive blends and/or concentrates. Therefore, the modified LDH according to the invention may be used efficiently and effectively in the synthesis of polymers. Preferably, used/included after the polymerisation of the polymer, providing a polymer composition including the modified LDH according to the invention and one or more of the aforementioned additives.

Yet another advantage of the modified LDH according to the invention is that the modified LDH is compatible with a variety of techniques in the synthesis of polymers. For example, extrusion, injection processes, additive blends, concentrates. The extrusion and/or injection may include thermoforming, extrusion blow moulding, sheet extrusion, extrusion compression moulding, pipe extrusion, film casting, blown film, raffia extrusion, tape extrusion, fibre extrusion, melt blown materials, spun bond fabrics, injection moulding, injection stretch blown moulding, injection blow moulding, compression moulding, roto-moulding, 3D-printing. Therefore, the modified LDH according to the invention may be efficiently and effectively used in the synthesis of polymers.

For example, a polymer composition comprising the modified LDH according to the invention may be used as a film, in cups, trays, pallets, and the like.

In a preferred embodiment according to the invention, the organic acid derivative or salts thereof may be one or more selected from mono- or di-carboxy-C₁₋₁₂ alkyl, C₁₋₁₂ alkyl sulfonyl hydroxide, C₁₋₁₂ alkyl phosphonic acid, bis C₁₋₁₂ alkyl phosphonate, N-substituted isocyanurate, mono-, di, or tri-carboxy-C₃₋₈ cycloalkane, an organic acid derivative according to formula (II),

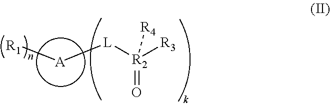

wherein:
k is an integer from 1 to 3;
n is an integer from 0 to 5;
A represents a cycloalkyl, aryl, or heteroaryl;
L represents a direct bond or NH;
R₁ is one or more independently selected from hydroxy, carboxyl, C₁₋₆ alkoxycarbonyl, arylcarbonylamino, amino, amide, C₁₋₆ alkyl, hydroxy phosphoryl, Het, or Ar;
Ar represents an aryl;
Het represents heterocycle;
R₂ represents C or P or S;
wherein R₃ is hydroxy and present when L represents a direct bond, or wherein R₃ is hydroxy or C₁₋₆ alkyl when L represents NH; and
wherein R₄ is hydroxy or C₁₋₆ alkylcarbonyl and present when R₂ represents P, or wherein R₄ is a doubled bonded oxygen and present when R₂ represents S.

In a preferred embodiment, n is an integer from 0 to 2.

It is noted that mono-, di, or tri-carboxy-C₃₋₈ cycloalkane may comprise substituents, preferably one or more C₁₋₆ alkyl. For example, said substituent may be positioned at the para position of a mono-carboxy cyclohexane.

In a further preferred embodiment according to the invention, the organic acid derivative or salts thereof may be one or more selected from mono- or di-carboxy-C₁₋₁₂ alkyl, C₁₋₁₂ alkyl sulfonyl hydroxide, C₁₋₁₂ alkyl phosphonic acid, bis C₁₋₁₂ alkyl phosphonate, an organic acid derivative according to formula (II),

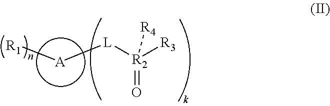

wherein:
k is an integer from 1 to 3;
n is an integer from 0 to 5;
A represents a cycloalkyl, aryl, or heteroaryl;
L represents a direct bond or NH;
R₁ is one or more independently selected from hydroxy, carboxyl, C₁₋₆ alkoxycarbonyl, arylcarbonylamino, amino, amide, C₁₋₆ alkyl, hydroxy phosphoryl, Het, or Ar;
Ar represents an aryl;
Het represents heterocycle;
R₂ represents C or P or S;
wherein R₃ is hydroxy and present when L represents a direct bond, or wherein R₃ is hydroxy or C₁₋₆ alkyl when L represents NH; and
wherein R₄ is hydroxy or C₁₋₆ alkylcarbonyl and present when R₂ represents P, or wherein R₄ is a doubled bonded oxygen and present when R₂ represents S. Preferably, formula II is represented by formula III,

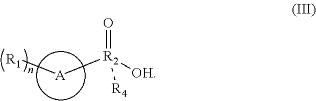

In a further preferred embodiment according to the invention, when A is a cycloalkyl, said cycloalkyl is a norbornane, norbornene, cyclobutyl, cyclopentyl, cyclopentenyl, cyclohexyl, or cyclohexenyl.

In a further preferred embodiment according to the invention, n is an integer from 0 to 2.

It is noted that different organic acid derivatives or salts thereof may be present in the modified LDH according to the invention. Thus, the organic acid derivative or salts thereof may be directly bonded with the outer layer of the LDH, providing a modified LDH according to the invention.

It is also noted that R₄ is not present in formula II and/or formula III when R₂ represents C.

An advantage of the abovementioned organic acid derivatives or salts thereof is that these provide an efficient and effective modified LDH which is preferably enabled to fulfil at least a dual functionality. As mentioned herein before, said dual functionality is preferably a functionality as acid scavenger and nucleating agent.

A further advantage of the abovementioned organic acid derivatives or salts thereof prevents and/or reduces undesired effects from halogens in the obtained polymer composition after the synthesis. Thus, the composition comprising the polymer and the modified LDH according to the invention is less influenced by said undesired effects.

In a further presently preferred embodiment according to the invention, A may be an aryl or heteroaryl.

It was found that A being an aryl or heteroaryl enables efficient and effective acid scavenging and nucleation in, for example, the synthesis of polymers.

In a preferred embodiment the modified layered double hydroxide according to the invention, comprises formula (I),

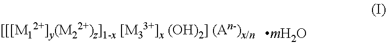

wherein:
M₁ and M₂ are each independently a divalent metal selected from the group of Mg, Zn, Ca, Sr, Cu, Fe, Mn, Co, Ni, Sn, Pb, Cd, and Ba; in particular Mg, Zn, Cu, Fe, Mn, Co, Ni, and Cd;
M₃ is trivalent metal such as Al and/or Fe; in particular Al; and
Aⁿ⁻ is one or more of an intercalating n-valent anion,
wherein m, x, y, and z are values in the ranges represented by:

$$0 \leq m < 2$$

$$0 < x \leq 0.5$$

$$0.5 \leq y + z \leq 1$$

further comprising a modified outer layer, wherein the outer layer is modified with an organic acid derivative or salts thereof,
wherein the organic acid derivative or salts thereof may be one or more selected from mono-or di-carboxy-C₁₋₁₂ alkyl, C₁₋₁₂ alkyl sulfonyl hydroxide, C₁₋₁₂ alkyl phosphonic acid, bis C₁₋₁₂ alkyl phosphonate, an organic acid derivative according to formula (II),

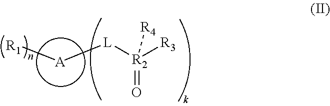

wherein:
k is an integer from 1 to 3;
n is an integer from 0 to 5;
A represents a cycloalkyl, aryl, heteroaryl, norbornane, or norbornene;
L represents a direct bond or NH;
R₁ is one or more independently selected from hydroxy, carboxyl, C₁₋₆ alkoxycarbonyl, arylcarbonylamino, amino, amide, C₁₋₆ alkyl, hydroxy phosphoryl, Het, or Ar;
Ar represents an aryl;
Het represents heterocycle;
R₂ represents C or P or S;
wherein R₃ is hydroxy and present when L represents a direct bond, or wherein R₃ is hydroxy or C₁₋₆ alkyl when L represents NH; and
wherein R₄ is hydroxy or C₁₋₆ alkylcarbonyl and present when R₂ represents P, or wherein R₄ is a doubled bonded oxygen and present when R₂ represents S, and
wherein A is independently selected from an aryl or heteroaryl.

In a further presently preferred embodiment according to the invention, n is an integer from 0 to 2.

It was found that said modified layered double hydroxide provides an efficient and effective nucleation and acid scavenging.

In a further preferred embodiment, the modified layered double hydroxide according to the invention, comprises formula (I),

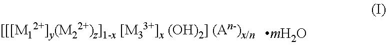

wherein:
M₁ and M₂ are each independently a divalent metal selected from the group of Mg, Zn, Ca, Sr, Cu, Fe, Mn, Co, Ni, Sn, Pb, Cd, and Ba; in particular Mg, Zn, Cu, Fe, Mn, Co, Ni, and Cd;
M₃ is trivalent metal such as Al and/or Fe; in particular Al; and
Aⁿ⁻ is one or more of an intercalating n-valent anion,
wherein m, x, y, and z are values in the ranges represented by:

$$0 \leq m < 2$$

$$0 < x \leq 0.5$$

$$0.5 \leq y + z \leq 1$$

further comprising a modified outer layer, wherein the outer layer is modified with an organic acid derivative or salts thereof,
wherein formula II is represented by formula III,

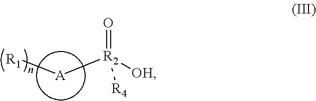

wherein A is independently selected from an aryl or heteroaryl.

It was found that said modified layered double hydroxide provides an efficient and effective nucleation and acid scavenging.

In addition, the ΔT is achieved when the modified LDH according to the invention is included in a polymerisation, for example a polymerisation of polypropylene, polyethylene, polylactic acid, polybutylene terephthalate, polybutylene adipate terephthalate, and the like.

An advantage of said crystallization temperature is that efficient and effective acid scavenging and nucleation of the modified LDH according to the invention is achieved.

In a preferred embodiment according to the invention, the organic acid derivative or salts thereof may be one or more selected from the group of bicyclo[2.2.1]heptane-2,3-dicarboxylic acid, cis-1,2-cyclohexanedicarboxylic acid, (1R, 2S)-2-methoxycarbonyl cyclohexane carboxylic acid, 1,3,5-tris(2,2-dimethylpropionylamino)benzene, 2,6-naphthalene dicarboxylic acid, benzoic acid, pimelic acid, phenylphosphonic acid, 2,6-dihydroxypyrimidine-4-carboxylic acid, 4-pyridinecarboxylic acid, benzene-1,3,5-tricarboxylic acid, 4-(benzoylamino)benzoic acid, disodium malonate, sodium acetate, 1-octanesulfonic acid, 2,3-pyridinedicarboxylic acid, 2-carboxyethyl (phenyl) phosphinic acid, 2-naphthalenecarboxylic acid, 2-tert-butylbenzoic acid, 4-amino benzoic acid, 4-biphenyl carboxylic acid, 4-toluenesulfonic acid, bis(2-ethylhexyl)hydrogen phosphate, butylphosphonic acid, 4-phthalimidobenzoic acid, 4-tert-butylbenzoic acid, 1,3,5-triazine-2,4,6-triol, 1,4-cyclohexanedicarboxylic acid, 4-propyl cyclohexane carboxylic acid. Preferably, the organic acid derivative or salts thereof may be one or more selected from the group of benzoic acid, cis-1,2-cyclohexanedicarboxylic acid, 2,6-naphthalene dicarboxylic acid, bicyclo[2.2.1]heptane-2,3-dicarboxylic acid (2.3-norbornanedicarboxylic acid), pimelic acid, phenylphosphonic acid, benzene-1,3,5-tricarboxylic acid, 1,3,5-triazine-2,4,6-triol, 4-amino benzoic acid, 1,4-cyclohexane dicarboxylic acid, 2-carboxyethyl (phenyl) phosphinic acid, 4-propyl cyclohexane carboxylic acid, butylphosphonic acid, 4-toluenesulfonic acid.

In a further presently preferred embodiment according to the invention, the organic acid derivative or salts thereof may be one or more selected from the group of bicyclo[2.2.1]heptane-2,3-dicarboxylic acid, cis-1,2-cyclohexanedicarboxylic acid, (1R, 2S)-2-methoxycarbonyl cyclohexane carboxylic acid, 1,3,5-tris(2,2-dimethylpropionylamino)benzene, 2,6-naphthalene dicarboxylic acid, benzoic acid, pimelic acid, phenylphosphonic acid, 2,6-dihydroxypyrimidine-4-carboxylic acid, 4-pyridinecarboxylic acid, benzene-1,3,5-tricarboxylic acid, 4-(benzoylamino)benzoic acid, disodium malonate, sodium acetate, 1-octanesulfonic acid, 2,3-pyridinedicarboxylic acid, 2-carboxyethyl (phenyl) phosphinic acid, 2-naphthalenecarboxylic acid, 2-tert-butylbenzoic acid, 4-amino benzoic acid, 4-biphenyl carboxylic acid, 4-toluenesulfonic acid, bis(2-ethylhexyl)hydrogen phosphate, butylphosphonic acid, 4-phthalimidobenzoic acid, 4-tert-butylbenzoic acid. Preferably, the organic acid derivative or salts thereof may be one or more selected from the group of bicyclo[2.2.1]heptane-2,3-dicarboxylic acid, cis-1,2-cyclohexanedicarboxylic acid, pimelic acid, phenylphosphonic acid, 2,6-naphthalene dicarboxylic acid.

An advantage of said acids is that a modified LDH particle comprising a Tc of at least 122° C. is achieved.

In a further presently preferred embodiment according to the invention, the organic acid derivative or salts thereof may be cis-1,2-cyclohexanedicarboxylic acid.

It was found that a modified LDH according to the invention comprising one or more of the abovementioned organic acid derivatives or salt thereof, in particular comprising cis-1,2-cyclohexanedicarboxylic acid, provides at least an efficient and effective acid scavenger and nucleator. Thus, provides an efficient and effective dual functionality.

In a further presently preferred embodiment according to the invention the modified LDH comprises an X-ray diffraction peak in the range of 4° 2Theta to 9° 2Theta.

It was found that cis-1,2-cyclohexanedicarboxylic acid enables a modified LDH comprising an X-ray diffraction peak in the range of 4° 2Theta to 9° 2 Theta.

In a further presently preferred embodiment according to the invention, the organic acid derivative or salts thereof comprises 1,3,5-triazine-2,4,6-triol.

It is noted that 1,3,5-triazine-2,4,6-triol is a N-substituted isocyanurate.

It was found that said 1,3,5-triazine-2,4,6-triol provides an average Tc of 121.90° C.

Furthermore, said organic acid derivative enables an efficient and effective acid scavenging and nucleation.

In a further presently preferred embodiment according to the invention, the organic acid derivative or slats thereof comprises a mono-, di-, or tri-carboxy cyclohexane, preferably wherein the mono-, di-, or tri-carboxy cyclohexane is 1,4-cyclohexanedicarboxylic acid and/or 4-propyl cyclohexane carboxylic acid.

An advantage of said acids is that a modified LDH particle comprising a Tc of at least 120.5° C. is achieved.

In a further presently preferred embodiment according to the invention, Aⁿ⁻ may be one or more selected from the group of a carbonate ion, nitrate ion, sulphate ion, or combinations thereof.

Preferably, Aⁿ⁻ may be a carbonate ion.

An advantage of the aforementioned group for Aⁿ⁻ is that acid scavenging of the modified LDH according to the invention is improved.

It was found that having intercalated Aⁿ⁻ provides acid scavenger properties to the modified LDH according to the invention.

The invention also relates to particles comprising the modified LDH according to the invention.

The particles comprising the modified LDH provide the same effects and advantages as those described for the modified LDH according to the invention.

It was found that the particles according to the invention provide, in particularly, beneficial effects in the synthesis of polypropylene and polyethylene.

In a presently preferred embodiment according to the invention, the particles may have an average secondary particle diameter measured by a dynamic light scattering method in the range of 1 nm to 2000 nm, preferably in the range of 3 nm to 1500 nm, more preferably in the range of 5 nm to 1000 nm.

It is noted that the dynamic light scattering is based on a quality control method, including particle size determination (based on volume distribution). The particle size distributions in water were measured on a Microtrac S3500 particle size analyser by laser diffraction method after ultrasonic treatment of the sample. To 0.35 g of sample, 2 mL MeOH was added and after 1 minute 35 mL of 0.2 w/v % sodium hexametaphosphate (deflocculant) was added. The sample was subsequently subjected to ultrasonic vibrations for 5 minutes. The sample was stirred, and 1 mL was taken from the sample with a pipette and injected into the particle size analyser.

It was found that particles having an average secondary particle diameter measured by a dynamic light scattering method in the range of 1 nm to 2000 nm, preferably in the range of 3 nm to 1500 nm, more preferably in the range of 5 nm to 1000 nm provide efficient and effective acid scavenging and nucleation.

In a further presently preferred embodiment according to the invention, the particles having an average secondary particle diameter measured by a laser diffraction method in the range of 0.01 μm to 20 μm, preferably in the range of 0.04 μm to 3 μm, more preferably in the range of 0.1 μm to 1 μm.

The invention also relates to a resin composition comprising a resin and particles according to the invention in the range of 1 ppm to 10000 ppm, preferably 50 ppm to 5000 ppm, more preferably 100 ppm to 3000 ppm.

The resin composition according to the invention provides the same effects and advantage as those described for the modified LDH according to the invention and the particles comprising the modified LDH according to the invention.

It is noted that the resin according to the invention comprises 1 ppm to 10000 ppm, preferably 50 ppm to 5000 ppm, more preferably 100 ppm to 3000 ppm, particles according to the invention compared to the resin.

In a preferred embodiment according to the invention, the resin may be one or more selected from the group of a polyolefin, a polyvinyl chloride, a poly vinyl alcohol, a poly lactic acid.

It was found that the resin being one or more selected from the group of a polyolefin, a polyvinyl chloride, a poly vinyl alcohol, a poly lactic acid enables efficient and effective acid scavenging and nucleation.

The invention also relates to a dispersion comprising a liquid and particles according to the invention in the range of 1 ppm to 10000 ppm, preferably 50 ppm to 5000 ppm, more preferably 100 ppm to 3000 ppm.

The dispersion according to the invention provides the same effects and advantages as those described for the modified LDH according to the invention, the particles comprising the modified LDH according to the invention, and resin composition according to the invention.

In a preferred embodiment, the liquid is one or more selected from the group of water, ethanol, methanol, propanol, ethyl acetate.

The invention also relates to a method for producing modified LDH according to the invention, comprising contacting a layered double hydroxide according to formula (I),

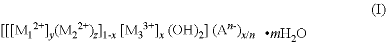

wherein.
M₁ and M₂ are each independently a divalent metal selected from the group of Mg, Zn, Ca, Sr, Cu, Fe, Mn, Co, Ni, Sn, Pb, Cd, and Ba; in particular Mg, Zn, Cu, Fe, Mn, Co, Ni, and Cd;
M₃ is trivalent metal such as Al and/or Fe; in particular Al; and
Aⁿ⁻ is one or more of an intercalating n-valent anion, wherein m, x, y, and z are values in the ranges represented by:

$$0 \leq m < 2$$

$$0 < x \leq 0.5$$

$$0.5 \leq y + z \leq 1$$

with an organic acid derivative or salts thereof.

The method for producing modified LDH according to the invention provides the same effects and advantage as those described for the modified LDH according to the invention, the particles comprising the modified LDH according to the invention, the dispersion according to the invention, and the resin composition according to the invention.

The method for producing modified LDH according to the invention includes the step of contacting the outer layer of a layered double hydroxide with an organic acid derivative or salts thereof.

It was found that the method according to the invention efficiently and effectively provides a modified LDH comprising a modified outer layer.

Furthermore, the method according to the invention may further include the synthesis of polymers, such as polymer compositions, using the modified LDH according to the invention. Said method comprises for example the mixing of the modified LDH in a polymer melt extruder via additive blends, a masterbatch, and/or concentrates with various polymer carriers, or in the form of a powder.

In a preferred embodiment according to the invention, the organic acid derivative or salts thereof is one or more selected from mono- or di-carboxy-C₁₋₁₂ alkyl, C₁₋₁₂ alkyl sulfonyl hydroxide, C₁₋₁₂ alkyl phosphonic acid, bis C₁₋₁₂ alkyl phosphonate, an organic acid derivative according to formula (II),

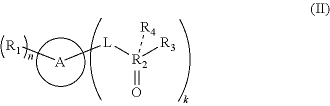

wherein:
k is an integer from 1 to 3;
n is an integer from 0 to 5;
A represents a cycloalkyl, aryl, or heteroaryl;
L represents a direct bond or NH;
R₁ is one or more independently selected from hydroxy, carboxyl, C₁₋₆ alkoxycarbonyl, arylcarbonylamino, amino, amide, C₁₋₆ alkyl, hydroxy phosphoryl, Het, or Ar;
Ar represents an aryl;
Het represents heterocycle;
R₂ represents C or P or S;
wherein R₃ is hydroxy and present when L represents a direct bond, or wherein R₃ is hydroxy or C₁₋₆ alkyl when L represents NH; and
wherein R₄ is hydroxy or C₁₋₆ alkylcarbonyl and present when R₂ represents P, or wherein R₄ is a doubled bonded oxygen and present when R₂ represents S.

In a preferred embodiment n is an integer from 0 to 2.

In a further presently preferred embodiment according to the invention, A may be an aryl or heteroaryl.

In a further presently preferred embodiment according to the invention, the organic acid derivative or salt thereof may be one or more selected from the group of bicyclo[2.2.1]heptane-2,3-dicarboxylic acid, cis-1,2-cyclohexanedicarboxylic acid, (1R, 2S)-2-methoxycarbonyl cyclohexane carboxylic acid, 1,3,5-tris(2,2-dimethylpropionylamino)benzene, 2,6-naphthalene dicarboxylic acid, benzoic acid, pimelic acid, phenylphosphonic acid, 2,6-dihydroxypyrimidine-4-carboxylic acid, 4-pyridinecarboxylic acid, benzene-1,3,5-tricarboxylic acid, 4-(benzoylamino)benzoic acid, disodium malonate, sodium acetate, 1-octanesulfonic acid, 2,3-pyridinedicarboxylic acid, 2-carboxyethyl (phenyl) phosphinic acid, 2-naphthalenecarboxylic acid, 2-tert-butylbenzoic acid, 4-amino benzoic acid, 4-biphenyl carboxylic acid, 4-toluenesulfonic acid, bis(2-ethylhexyl)hydrogen phosphate, butylphosphonic acid, 4-phthalimidobenzoic acid, 4-tert-butylbenzoic acid.

In a preferred embodiment, the organic acid derivative or salts thereof may be one or more selected from the group of bicyclo[2.2.1]heptane-2,3-dicarboxylic acid, cis-1,2-cyclohexanedicarboxylic acid, pimelic acid, phenylphosphonic acid, 2,6-naphthalene dicarboxylic acid.

The invention also relates to the use of the modified layered double hydroxide according to the invention, the particles according to the invention, resin composition according to the invention, and/or dispersion according to the invention in the polymer industry, wherein the polymer industry comprises the synthesis of polymers, productions of polymer compositions, conversion of polymer compositions into consumables.

The use in the polymer industry of said modified LDH provides the same effects and advantage as those described for the modified LDH according to the invention, the particles comprising the modified LDH according to the invention, the dispersion according to the invention, the resin composition according to the invention, and method for producing modified LDH according to the invention.

It was found that the modified LDH according to the invention is particularly beneficial in the synthesis of polymers, such as polypropylene comprising homopolymers, random copolymers and heterophasic copolymers, polyethylene comprising high-density polyethylene (HDPE), low-density polyethylene (LDPE), linear low-density polyethylene (LLDPE), and the like. In said synthesis the modified LDH according to the invention may be used as an acid scavenger and a nucleating agent.

In a further preferred embodiment according to the invention, the modified LDH according to the invention is used to increase the crystallisation temperature in the processing of the crystalline thermoplastic polymers and/or semi-crystalline polymers.

In a further preferred embodiment according to the invention, the increased crystallisation temperature is increased with at least 0.5° C., preferably of at least 1° C., more preferably of at least 2° C., even more preferably at least 3° C., even more preferably at least 4° C., most preferably at least 5° C. according to EN ISO 11357-3:2018.

It is noted that a ΔT represents subtraction of a crystallization temperature without the modified LDH from a crystallization temperature comprising the modified LDH.

In a further preferred embodiment according to the invention, the crystalline thermoplastic polymer is polypropylene, and having a crystallization temperature of at least 120.05° C., preferably of at least 121° C., more preferably of at least 122° C., even more preferably at least 123° C., even more preferably at least 124° C., most preferably at least 125° C. according to EN ISO 11357-3:2018.

Further advantages, features and details of the invention are elucidated on the basis of preferred embodiments thereof, wherein reference is made to the figures and to the accompanying experiments.

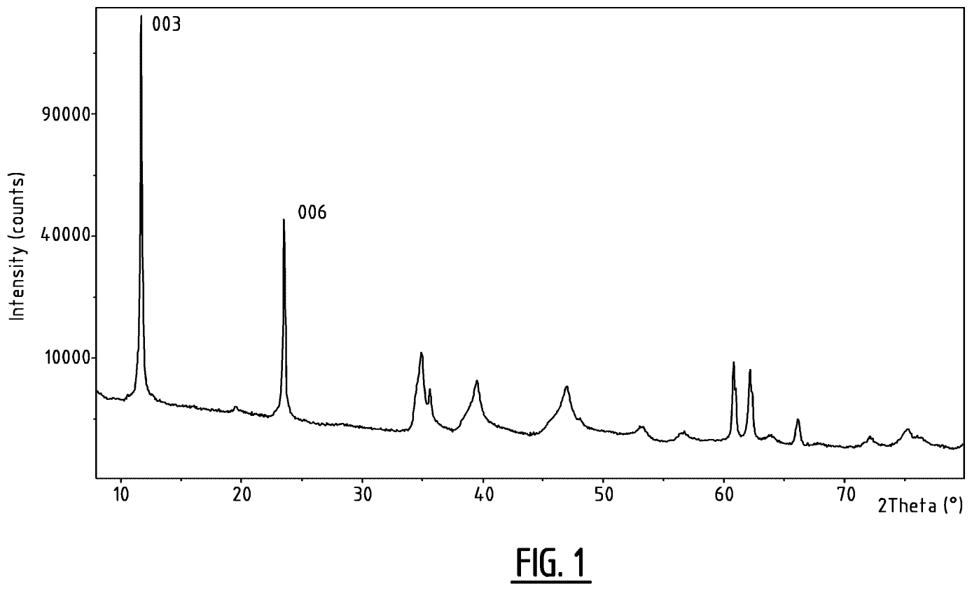

FIG. 1: shows the X-ray diffraction of cis-1,2-cyclohexanedicarboxylic acid modified LDH according to the invention;

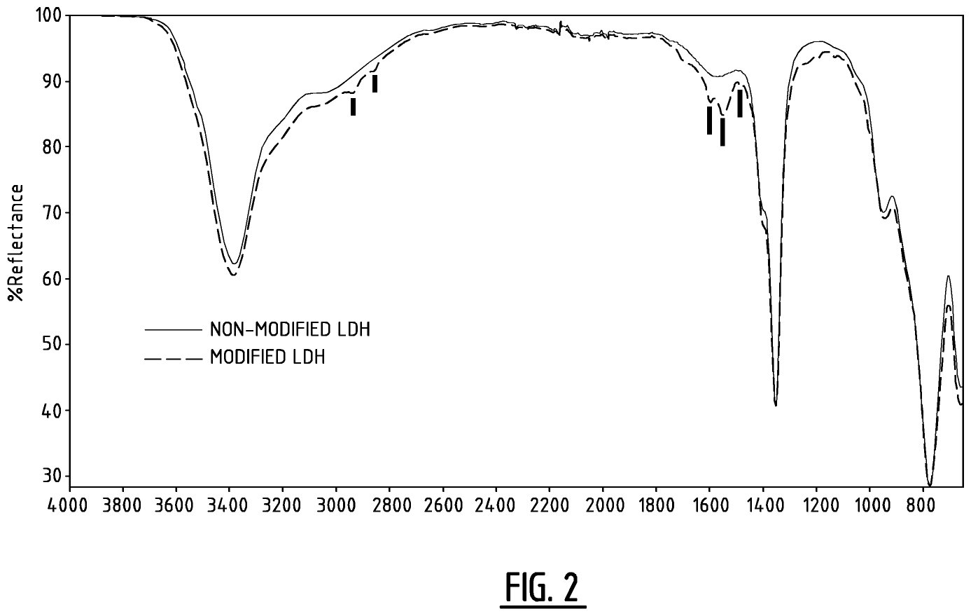

FIG. 2: shows a FT-IR of the cis-1,2-cyclohexanedicarboxylic acid modified LDH according to the invention;

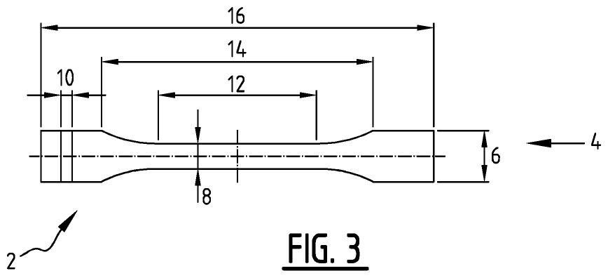

FIG. 3: shows the tensile test specimen;

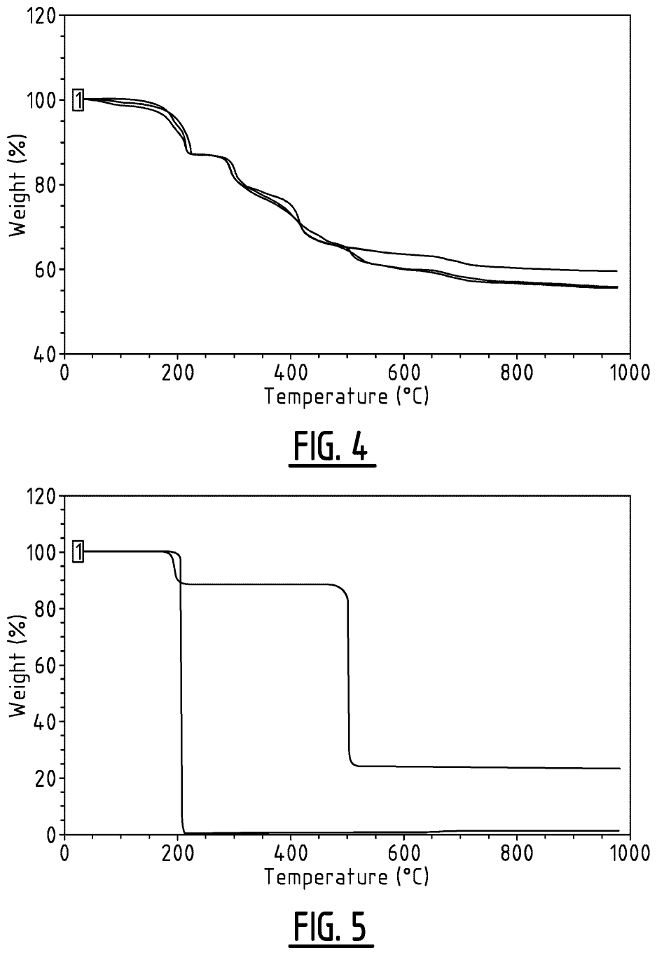

FIG. 4: shows the decomposition curve of both cis-1,2-cyclohexanedicarboxylic acid modified LDH samples synthesized according to the first method and the second method;

FIG. 5: shows the TGA of cis-1,2-cyclohexanedicarboxylic acid magnesium salt and cis-1,2-cyclohexanedicarboxylic acid;

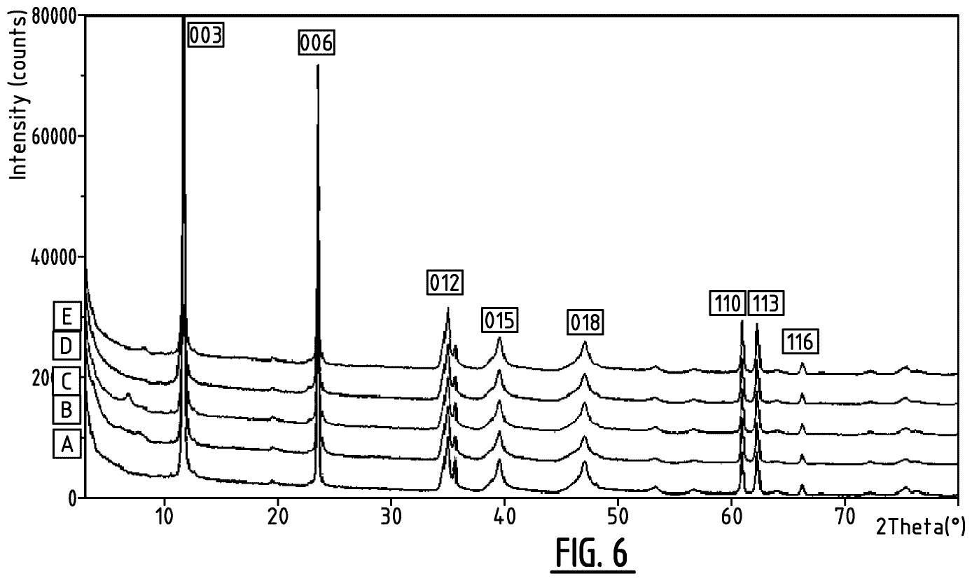

FIG. 6: shows a XRD pattern of synthesized samples

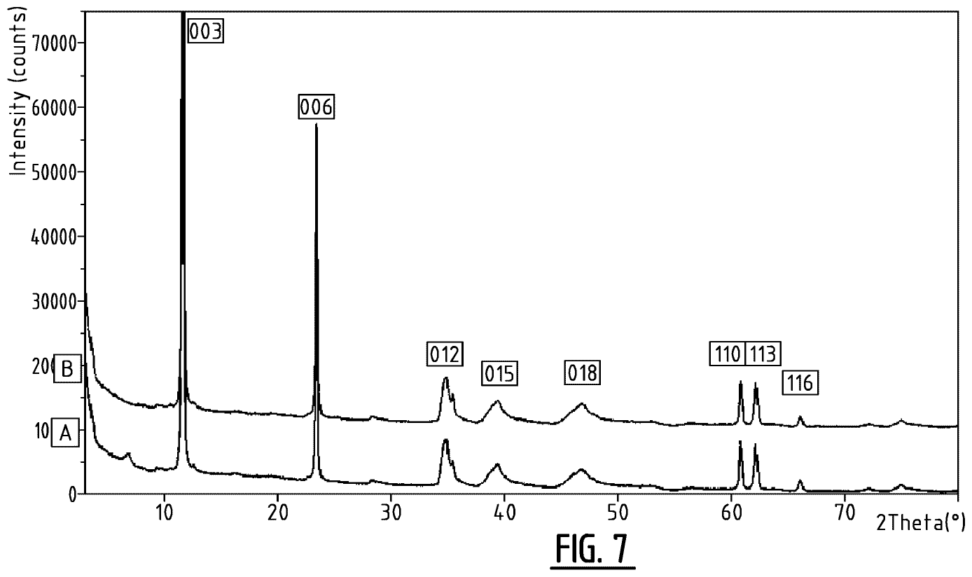

FIG. 7: shows XRD pattern of cis-1,2-cyclohexanedicarboxylic acid modified LDH particles;

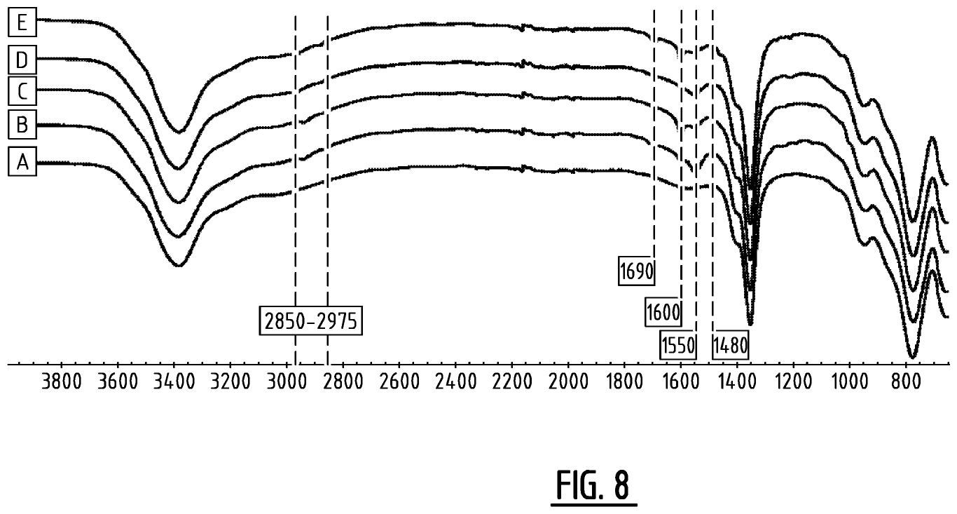

FIG. 8: shows a FT-IR spectra of synthesized samples;

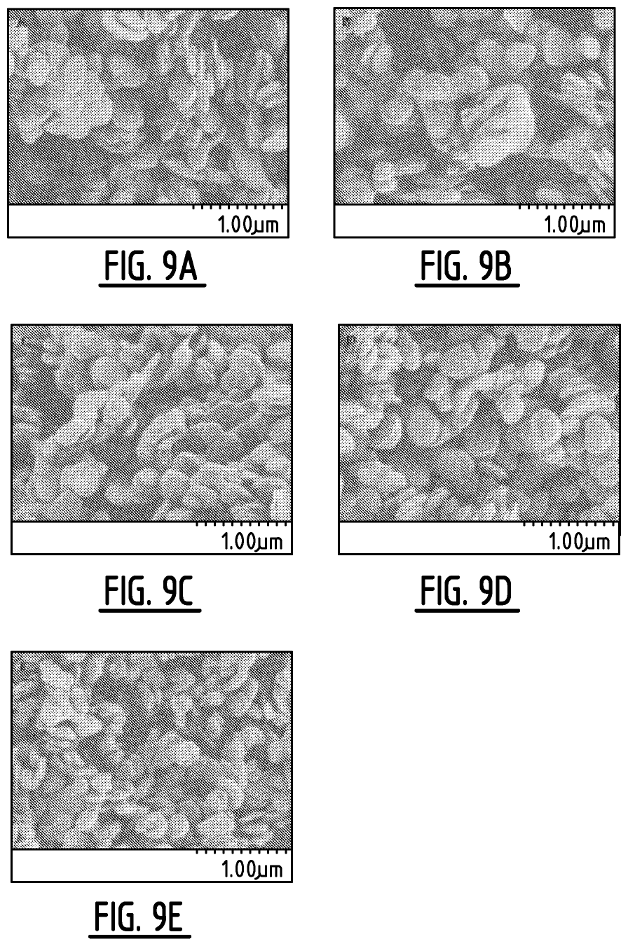

FIG. 9: shows SEM images of the synthesized samples;

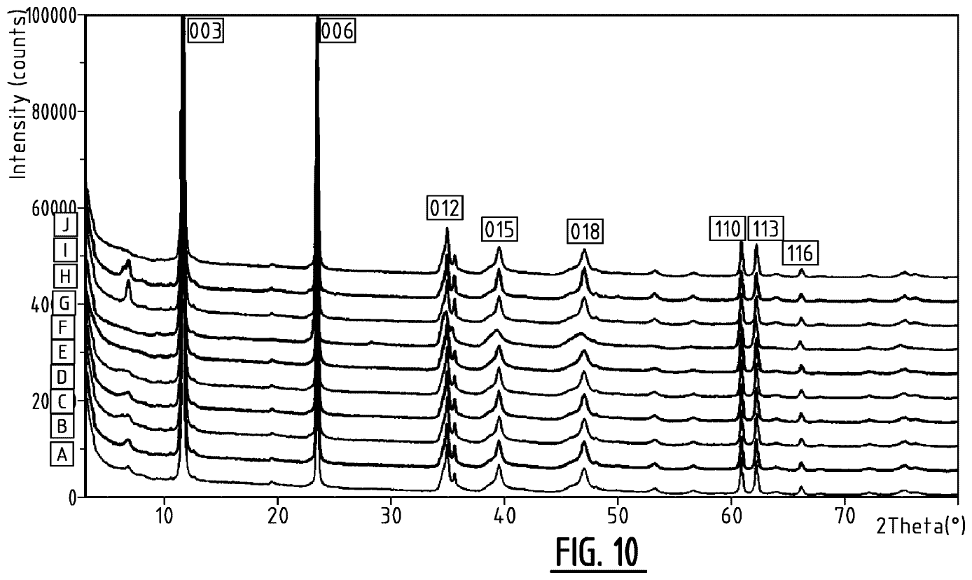

FIG. 10: shows the XRD patterns of the samples mentioned in Table 5;

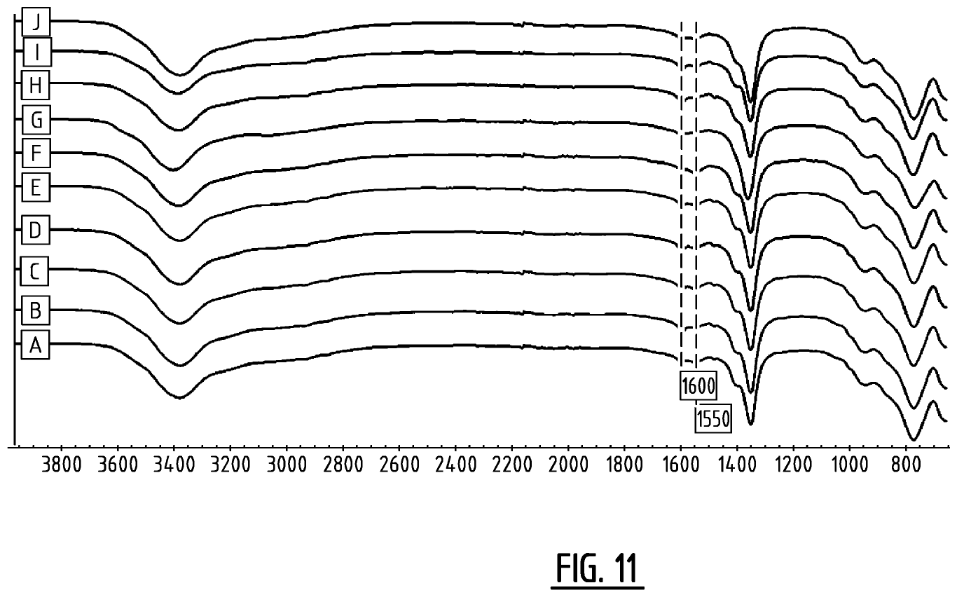

FIG. 11: shows the FT-IR spectra of the samples mentioned in Table 5;

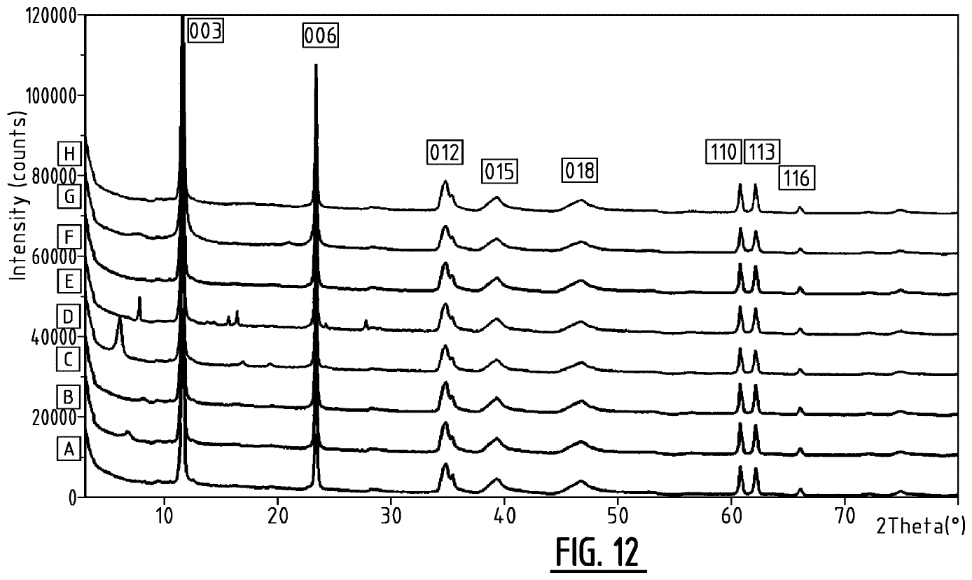

FIG. 12: shows XRD patterns of different LDH particles according to the invention;

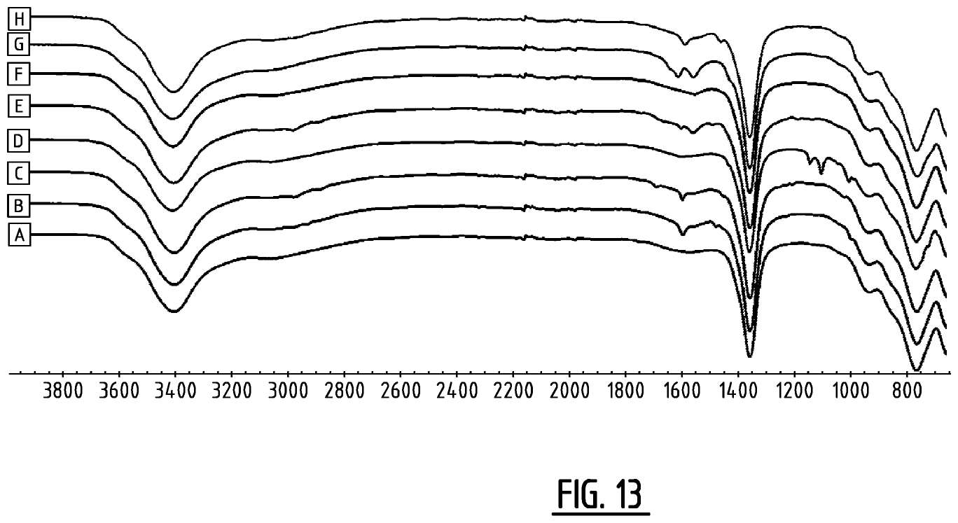

FIG. 13: shows FT-IR spectra of different LDH particles according to the invention; and

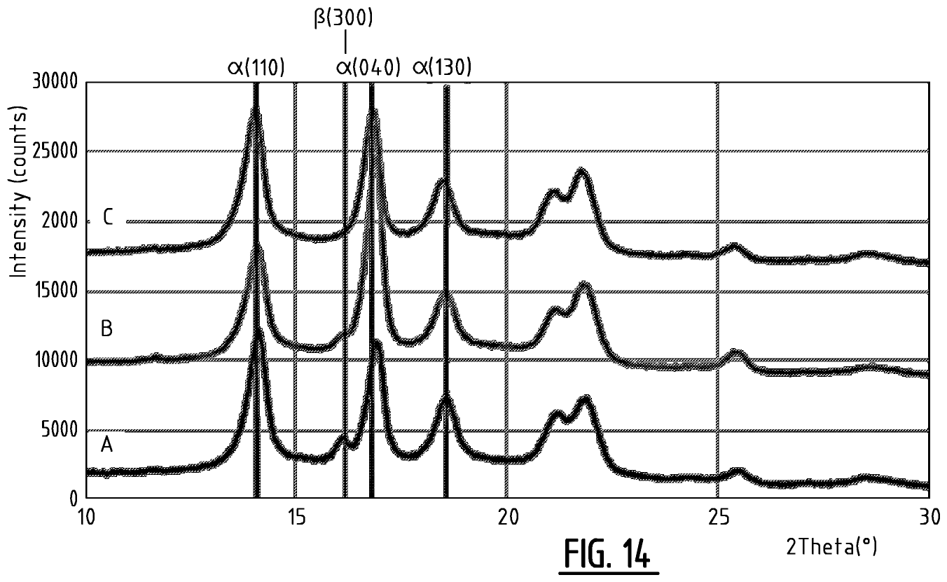

FIG. 14: shows WAXD pattern of the cis-1,2-cyclohexanedicarboxylic acid modified LDH and bicyclo[2.2.1]heptane-2,3-dicarboxylic acid modified LDH.

In an experiment the modified LDH according to the invention has been synthesized. Said synthesis started with weighing 50 g of layered double hydroxide into a two-necked flask, and 200 ml of demineralized water was added to said flask and stirred at 18° C. A reflux condenser was installed on the first neck of said flask and a dropping funnel on the second neck of said flask. 5 g of cis-1,2-cyclohexanedicarboxylic acid (HHPA) dissolved in 50 ml EtOH was added to the dropping funnel before being added slowly (about 1 drop per second) to the stirred layered double hydroxide dispersion. After the cis-1,2-cyclohexanedicarboxylic acid dissolved in EtOH was added, the dispersion was heated to reflux temperature for 2 hours. The solids were filtered and washed for 5 times with demineralized water. After the washing the obtained solid was dried.

The solid was analysed using FT-IR, SEM, and XRD. It was found that a modified LDH has been synthesized which has both acid scavenging and nucleation functionality.

XRD Analyses Showed: X-ray diffraction is used for the determination of the basal-spacing and crystallographic structure of the cis-1,2-cyclohexanedicarboxylic acid modified LDH.

X-ray diffraction spectra are recorded on a Panalytical X-pert powder spectrometer with PIXcal1D-Medipix3 collaboration RTMS detector using the scanning line detector. For these measurements Cu Kα radiation (λ=1.54 Å) was used. The step size of the goniometer was 0.026°2θ at a counting time of 296.565 s. The spectra are recorded at 45 kV and 40 mA.

Focus length 12.0 mm, width 0.4 mm and take-off angle of 6.0°. Beta-filter Nickel with a thickness of 0.020 mm. Soller slit 0.02 rad. Fixed incident beam mask 15 mm, width 11.60 mm. Anti-scatter slit Fixed slit ½ °, with a height of 0.76 mm. Divergence slit Fixed slit ¼° with height 0.38 mm.

For the diffracted beam path, the used radius was 240.0 mm. Anti-scatter slit AS slit 8.0 mm (PIXcel) fixed type with a height of 8.0 mm. A large soller slit 0.02 rad. Large beta-filter Nickel 0.020 mm thickness.

The resulting X-ray diffractogram for the material is shown in FIG. 1. X-ray diffraction is used for the determination of the basal-spacing and crystallographic structure of the cis-1,2-cyclohexanedicarboxylic acid modified LDH. The positions for the peaks 003 (7.5 Å) and 006 (3.8 Å), as labelled in the FIG. 1, are indicative for intercalated carbonate (CO₃²⁻) in the cis-1,2-cyclohexanedicarboxylic acid modified LDH according to the invention. The observed peaks of FIG. 1 indicate that the cis-1,2-cyclohexanedicarboxylic acid modified layered double hydroxide is a layered double hydroxide.

### XRF Analyses Showed:

X-ray fluorescence data are recorded on a Panalytical Axios spectrometer equipped with a Rh-tube. Samples are prepared by mixing the material (7.0 g) and an inert binder material, Elvacite 2046, (2 mL of an acetone solution, 40 g/200 mL) in a mortar. After evaporation of the acetone, a pellet is pressed of the material. The X-ray fluorescence spectrometer was used to determine the MII and MIII contents of the samples, displayed as M^{II}O and M^{III}O₃ respectively, as percentages of the total sample weight.

The modified cis-1,2-cyclohexanedicarboxylic acid modified LDH according to the invention has been analysed using FT-IR. FT-IR scans are recorded on a Thermo Scientific Nicolet iS10, equipped with a Smart iTX ATR sampling accessory and diamond crystal. No. of scans=32, Resolution=4, Data spacing=0.482 cm-1 and the Final Format=% Reflectance. The resulting data is shown in FIG. 2.

FIG. 2 shows a comparison between non-modified LDH (upper line at 3200 cm⁻¹) and cis-1,2-cyclohexanedicarboxylic acid modified LDH (lower line at 3200 cm⁻¹). The FT-IR spectrum of cis-1,2-cyclohexanedicarboxylic acid modified LDH shows a number of additional peaks, compared to non-modified LDH. Most significantly, peaks located around 1470 cm⁻¹ to 1660 cm⁻¹ (range of organic bonds) and 2800 cm⁻¹ to 3000 cm⁻¹ (CH/CH₂ bond).

### Organic Component Analysis Showed:

Identification/quantification of the organic components of the modified LDH may be achieved using ion chromatography and/or liquid chromatography (LC) in combination with conductivity detection and/or a mass spectrometer.

The modified LDH may be dissolved in acid, preferably further diluted, after which the solution is injected on to an IC column and/or LC system. Identification can then be achieved by comparing the Rt of the samples organic component to that of the pure organic component used, while quantification may achieved by preparing a calibration line for the organic component and comparing detector-intensity of the sample with the calibration line.

In a further experiment a modified LDH comprising cis-1,2-cyclohexanedicarboxylic acid, synthesized as described above, was added to polypropylene, preferably a homopolymer of polypropylene with melt flow index of 10, by extrusion. Concentration was varied and calcium stearate (CaSt) may have been added to the various samples (see Table 1). Properties were determined using by DSC analysis and the mechanical properties.

Powder blends of polypropylene with modified LDH according to the invention, antioxidants were prepared and fed into a fully cleaned twin screw extruder. The product was granulated and injection moulded into tensile bars for measurements. The concentration of the modified LDH according to the invention in the different samples (or compositions) varied and is indicated in Table 1. Thus, the modified LDH in each sample is the same. Between sample extrusion, the extruder was cleaned by purging with polypropylene and antioxidants.

TABLE 1
Samples comprising cis-1,2-cyclohexanedicarboxylic
acid modified LDH according to the invention.

| | | cis-1,2- | | | | |
|---|---|---|---|---|---|---|
| | | cyclohexane- | | | | |
| | Calcium | dicarboxylic acid | Tc | | | |
| | stearate | ModifiedLDH | (° C.) | Modulus | S_{L} | S_{W} |
| Sample | (ppm) | (ppm) | peak | (MPa) | (%) | (%) |
| 1 | 500 | | 121.3 | 1340 | −1.3 | −1.1 |
| 2 | 500 | 500 | 126.8 | 1510 | −1.2 | −1.6 |
| 3 | 500 | 1000 | 126.8 | 1510 | −1.3 | −1.7 |
| 4 | 500 | 2000 | 127.6 | 1530 | −1.3 | −1.5 |
| 5 | | 500 | 126.7 | 1470 | −1.1 | −1.5 |
| 6 | | 1000 | 127.3 | 1500 | −1.0 | −1.5 |
| 7 | | 2000 | 127.7 | 1560 | −1.0 | −1.9 |

The twin-screw-extrusion and injection moulding were performed using the parameters disclosed in Table 2.

TABLE 2
Twin-screw-extrusion and injection moulding parameters.
Twin-screw-extrusion

| Collin | 25 mm, L/D | | | | | |
|---|---|---|---|---|---|---|
| Temperature zone | 1 | 2 | 3 | 4 | 5 | 6 |
| Temperature (° C.) | 60 | 215 | 220 | 220 | 205 | 200 |

| | |
|---|---|
| Melt temperature (° C.) | 201 |
| Rotation speed (rpm) | 140 |
| Feed | Direct |
| Injection moulding: | Arburg |
| Temperature (° C.) | 220 |
| Injection speed (m min⁻¹) | 25 |
| Injection volume (ccm) | 24 |
| Pressure (bar) | 150 |
| Cooling time (s) | 23 |

The samples were analysed using Differential Scanning Calorimetry (DSC). The extruded samples were placed in an aluminium (Tzero) sample cup and analyzed by a TA Instrument Q2000 DSC. The used temperature program was Ramp from 180° C. to 20° C. The material is heated to an elevated temperature, to erase previous thermal history, then cooled at a linear rate. The analysis was performed in an inert atmosphere, by using purge nitrogen gas (N₂). The parameters for performing the DSC are provided in Table 3. The crystallisation behaviour was analysed from the cooling curve.

TABLE 3
Parameters DSC.

| | |
|---|---|
| Start temperature (° C.) | 50 |
| Heating rate (° C. min⁻¹) | 10 |
| Upper temperature (° C.) | 200 |
| Cooling rate (° C. min⁻¹) | 10 |
| Lower temperature (° C.) | 20 |

The tensile properties have been determined by injection moulding the samples into sample bars of type 1A as described in the ISO 527-2 standard and test according to method B. An Instron 3365 tensile tester with tensiometer was used.

In addition, the mould shrinkage was tested using ISO 294-4. The shrinkage of the samples were determine as described in the standard ISO 294-4, with the exception that the test specimen are tensile test bars (type 1A). The measuring device is a micrometer that measures dimension with 0.001 mm resolution. The dimensions are measured with 0.01 mm accuracy. The shrinkage was measured 24 hours and 72 hours after injection moulding. FIG. 3 shows tensile test specimen 2, with injection direction 4 and dimensions 6, 8, 10, 12, 14, and 16. Dimension 6 is 20 mm, dimension 8 is 10 mm, dimension 10 is 4 mm, dimension 12 is 80 mm, dimension 14 is 109.3 mm, and dimension is 170 mm.

To determine the nucleation behaviour of the polypropylene samples with (conventional) nucleation agent added and with modified LDH according to the invention added were made. The crystallisation temperature of said samples was determined by differential scanning calorimetry. A 5 mg sample of the injection moulded materials was heated to 200° C. to erase all thermal history and then cooled to 20° C. to analyse the crystallisation exotherm. The results are provided in Table 1.

These results show the nucleating effect of the samples comprising cis-1,2-cyclohexanedicarboxylic acid modified LDH samples on polypropylene. The crystallisation temperature increases 6° C. with increased concentration 500 ppm, 1000 ppm, 2000 ppm.

These results show that the samples provide an efficient and effective nucleation effect compared to conventional layered double hydroxides. In fact, the cis-1,2-cyclohexanedicarboxylic acid modified LDH according to the invention provides nucleation and acid scavenging. The selected variables have very little effect. It can be concluded that addition of CaSt does not provide significant differences compared to samples without CaSt. Furthermore, increasing the concentration of cis-1,2-cyclohexanedicarboxylic acid modified LDH shows little increased crystallisation temperature.

The mechanical properties of the samples and references were determined and are listed in Table 1. The tensile properties are compared to the un-nucleated polypropylene (with CaSt). These results show a modulus increase of 10% to 16% for the nucleation comprising the cis-1,2-cyclohexanedicarboxylic acid modified LDH, and the strain at break reduces 50% to 60% compared to using conventional layered double hydroxide (not shown).

These results indicate that the sample nucleated by 500 ppm to 2000 ppm cis-1,2-cyclohexanedicarboxylic acid modified LDH are providing an improved nucleation and/or acid scavenging compared to conventional layered double hydroxides.

Furthermore, the dimensions of the injection moulded samples were measured 72 hours after production. The shrinkage in injection direction (S_{L}) and perpendicular (S_{W}) are calculated according to the standard. Results are provided in Table 1. The samples nucleated with cis-1,2-cyclohexanedicarboxylic acid modified LDH according to the invention show 1% to 2% shrinkage after 72 hours. This is comparable to conventional layered double hydroxides.

It was found that the samples comprising the cis-1,2-cyclohexanedicarboxylic acid modified LDH comprises excellent isotropic shrinkage properties.

The cis-1,2-cyclohexanedicarboxylic acid modified LDH according to the invention have a nucleating effect as well as acid scavenging effect on polypropylene.

In a further experiment cis-1,2-cyclohexanedicarboxylic acid modified LDH and bicyclo[2.2.1]heptane-2,3-dicarboxylic acid modified LDH were synthesized (it is noted that in this application HHPA refers to cis-1,2-cyclohexanedicarboxylic acid and NOR refers to 2,3-norbornanedicarboxylic acid or bicyclo[2.2.1]heptane-2,3-dicarboxylic acid as 2,3-norbornanedicarboxylic acid and bicyclo[2.2.1]heptane-2,3-dicarboxylic acid refer to the same compound).

A first synthesis method starts by weighing 15 g of the LDH into a round-bottom flask of 250 mL and 135 mL demineralized water is added and stirred at room temperature. A dropping funnel is attached to the neck of said flask, which contains 1.5 g of cis-1,2-cyclohexanedicarboxylic acid and/or bicyclo[2.2.1]heptane-2,3-dicarboxylic acid dissolved in 7 mL ethanol. The cis-1,2-cyclohexanedicarboxylic acid or bicyclo[2.2.1]heptane-2,3-dicarboxylic acid solution is added slowly and dropwise to the stirring LDH dispersion. After addition of the cis-1,2-cyclohexanedicarboxylic acid and/or bicyclo[2.2.1]heptane-2,3-dicarboxylic acid solution the dropping funnel is replaced by a cooler and is the LDH dispersion heated to reflux temperature. Once reflux temperature has been reached, the dispersion continued to reflux for another two hours. The dispersion was let to cool down and the solids were filtered on a Buchner funnel with a Whatmann 42 filter of 90 mm diameter and washed 5 times with about 30 mL demineralized water. After washing, the solids were dried overnight at 70° C.

Alternatively, a second synthesis method starts by weighing 20 g of the LDH into a glass beaker of 400 mL and followed by adding 2 g of cis-1,2-cyclohexanedicarboxylic acid and/or bicyclo[2.2.1]heptane-2,3-dicarboxylic acid and 200 g demineralized water. The dispersion is stirred for 30 minutes at room temperature. After 30 minutes of stirring the beaker is covered with aluminum foil and heated to 80° C. Once the temperature has reached 80° C. the reaction remained at this temperature for another two hours. After two hours the dispersion is let to cool down and the solids are filtered on a Buchner funnel with a Whatmann 42 filter of 90 mm diameter. After the filtration the solids are dried overnight at 70° C.

The crystallization temperature (Tc) has been determined by a Mettler Toledo DSC 3+, temperature range of 50° C. to 200° C. and heating/cooling rate of 10° C. min⁻¹. Said analyses have been performed according to EN ISO 11357-3:2018.

It was found that the sample composition comprises homopolymer polypropylene (PP) with melt flow index of 3, Irganox® 1010, Irgafos® 168 and LDH sample in approximated the following ratio 99.800/0.050/0.100/0.050, wherein the amount of LDH can increase or decrease and is compensated by the amount of PP. All further crystallization temperature analyses of PP containing LDH particles measured by DSC are prepared according to the settings mentioned in Table 4.

TABLE 4
Single-screw extrusion and injection molding parameters.
single-screw-extrusion

| Collin | 25 mm, L/D | | | | |
|---|---|---|---|---|---|
| Screw | 3:1 single screw | | | | |
| Temperature zone | 1 | 2 | 3 | 4 | 5 |
| Temperature (° C.) | 210 | 220 | 220 | 220 | 220 |
| Rotation speed (rpm) | 100 | | | | |
| Output | Approx. 1.8 kg h⁻¹ | | | | |
| Injection moulding: | Arburg 320C ge | | | | |
| Temperature zone | 1 | 2 | 3 | 4 | 5 |
| Temperature (° C.) | 210 | 220 | 220 | 220 | 220 |

| | |
|---|---|
| Mold temperature | 40 |
| Cooling time (s) | 23 |
| Iso norm | 1873-2: 2007 |

Furthermore, the crystalline analysis of LDHs was performed using X-ray diffraction (XRD). Said XRD were recorded on a Panalytical X-pert powder spectrometer with PIXcallD-Medipix3 collaboration RTMS detector using the scanning line detector. For these measurements Cu Kα radiation (λ=1.54 Å) was used. The step size of the goniometer was 0.18380 2Theta at a counting time of 5157.63 s, scan range 5.000-80.001 with no. of point 408. The spectra were recorded at 45 kV and 40 mA. Focus length 12.0 mm, width 0.4 mm and take-off angle of 6.0°. Beta-filter Nickel with a thickness of 0.020 mm. Soller slit 0.02 rad. Fixed incident beam mask 15 mm, width 11.60 mm. Anti-scatter slit Fixed slit ½°, with a height of 0.76 mm. Divergence slit Fixed slit ¼° with height 0.38 mm.

In addition, FT-IR is used for the identification of the organic compounds after the LDH is modified with acid. FT-IR spectra obtained at a resolution of 4 cm⁻¹ were conducted by Thermo scientific Nicolet iS10 FT-IR spectrometer with ATR unit. The measurement range for all samples is 4000 cm⁻¹ to 600 cm⁻¹.

To observe the distribution and morphology of the surface modification on the LDHs the samples were examined by Scanning Electron Microscopy (SEM). The SEM images were obtained with a SU7000 device from Hitachi. The samples were measured at an condition=Vacc=1.00 kV Mag=“mentioned within the images” WD=“mentioned within the images”. Samples were prepared by dispersing a small amount of sample in isopropyl alcohol. Circa one to two drops of the dispersion are put on an aluminium stub and dried before placing the stub in the SEM.

Thermogravimetric analyses (TGA) of the samples were performed on a TA instruments Q500 apparatus, equipped with a Pt pan, to determine the total weight loss of the substance up to 1000° C. or 750° C. after change in method. A dynamic rate high resolution program was used to obtain the data (Hi-Res sensitivity 1.0, Ramp 50.00° C. mini, resolution 4.0). Helium gas was used to create an inert atmosphere in all analyses. Furthermore, it is possible to predict the total amount of cis-1,2-cyclohexanedicarboxylic acid on the sample with equation I. It is noted that cis-1,2-cyclohexanedicarboxylic acid is referred to as Q in equation I.

$$Amount of Q ( \% ) = ( \frac{L D H - Q 450 ° C . to 550 ° C . weight loss ( \% )}{L D H - Q total weight loss ( \% )} - \frac{LDH 450 ° C . to 550 ° C . weight loss ( \% )}{LDH total weight loss ( \% )} ) * 100 \% \qquad Equation I$$

The synthesized LDH according to the invention has also been analysed by LC-MS/MS. The used method for the analysis of cis-1,2-cyclohexanedicarboxylic acid (CAS: 610-09-3) and bicyclo[2.2.1]heptane-2,3-dicarboxylic acid (CAS: 1724-08-9) includes using multiple reaction monitoring (MRM) with negative ionization mode. UPLC: Sciex ExionLC™, Detector: Sciex QTRAP 4500, Software: Analyst 1.7, MultiQuant 3.0.3, Analytical Column: Waters CSH C18, 2.1×100 mm, 1.7 μm.

MRM transition: cis-1,2-cyclohexanedicarboxylic acid: m/z 170.9/126.8 and 170.9/152.9, bicyclo[2.2.1]heptane-2,3-dicarboxylic acid: m/z 182.9/139.1 and 182.9/182.9, phenylphosphonic acid and pimelic acid: m/z 159, benzene-1,3,5-tricarboxylic acid: m/z 209, 2,6-naphthalenedicarboxylic acid: m/z 216 and 1,4-cyclohexanedicarboxylic acid: m/z 171.

The samples (˜0.1 g) were extracted with 5 mL 1M HCl at 80° C. for 4 hours. 5 mL methanol was added to the extracts. The extracts were vortexed, diluted with methanol and analysed by LC-MS/MS. The quantification was performed against an external calibration line of the requested components standards with known concentrations. The analysis was performed in duplicate.

Extraction in 1M HCl at 80° C. proved sufficient to dissolve the inorganic fraction.

The obtained results for cis-1,2-cyclohexanedicarboxylic acid modified LDH and bicyclo[2.2.1]heptane-2,3-dicarboxylic acid modified LDH are provided in Table 5. Entry 1 refers to a sample of untreated LDH, entry 2 refers to a sample of cis-1,2-cyclohexanedicarboxylic acid modified LDH obtained according to the first synthesis method, entry 3 refers to a sample of bicyclo[2.2.1]heptane-2,3-dicarboxylic acid modified LDH obtained according to the first synthesis method, entry 4 refers to a sample of cis-1,2-cyclohexanedicarboxylic acid modified LDH obtained according to the second synthesis method, and entry 5 refers to a sample of bicyclo[2.2.1]heptane-2,3-dicarboxylic acid modified LDH obtained according to the second synthesis method.

TABLE 5
Overview of LDH samples results.

| | Entry | Entry | Entry | Entry | Entry |
|---|---|---|---|---|---|
| | 1 | 2 | 3 | 4 | 5 |
| DSC_Tc (° C.) | 120.9 | 125.6 | 123.0 | 126.1 | 126.9 |
| Concentration LC/MS (%) | N/A | 5.75 | 3.65 | 4.80 | 4.30 |
| Concentration TGA (%) | N/A | 9.23 | N/A | 6.82 | N/A |

Compared to the untreated LDH an increased Tc have been found for all surface modified samples, which implies that both methods (first method and second method) are usable to treat the surface of the LDH. However, as can been seen in Table 5 both cis-1,2-cyclohexanedicarboxylic acid and bicyclo[2.2.1]heptane-2,3-dicarboxylic acid modified samples according to the second method show increased Tc compared to the samples obtained according to the first method. This implies that the second method can be used instead of the first method regarding the Tc.

Both the concentration determination according to the LC/MS and TGA shows that the cis-1,2-cyclohexanedicarboxylic acid modified LDH comprises more cis-1,2-cyclohexanedicarboxylic acid when produced according to the first method instead of the second method. This observation indicates that a higher amount of cis-1,2-cyclohexanedicarboxylic acid does not necessarily means a higher Tc. For bicyclo[2.2.1]heptane-2,3-dicarboxylic acid modified LDH a higher amount of bicyclo[2.2.1]heptane-2,3-dicarboxylic acid has been found in the second method sample compare to the first method samples according to the LC/MS.

FIG. 4 shows the decomposition curve of cis-1,2-cyclohexanedicarboxylic acid modified LDH samples synthesized by the first method and synthesized by the second method compared to the untreated sample. The most significant differences between the curves can be observed between the range of 450° C. to 550° C. This loss only occurs to the cis-1,2-cyclohexanedicarboxylic acid modified LDH samples and therefore could be said that it is caused by the treatment with cis-1,2-cyclohexanedicarboxylic acid.

It is noted that the top line at 700° C. refers to untreated LDH, the middle line at 700° C. refers to cis-1,2-cyclohexanedicarboxylic acid modified LDH synthesized using the first method and the bottom line at 700° C. refers to cis-1,2-cyclohexanedicarboxylic acid modified LDH synthesized using the second method.

FIG. 5 shows that the weight loss at 450° C. to 550° C. is caused by magnesium salt of cis-1,2-cyclohexanedicarboxylic acid and not from cis-1,2-cyclohexanedicarboxylic acid which is at 200° C. This shows that the cis-1,2-cyclohexanedicarboxylic acid form on the cis-1,2-cyclohexanedicarboxylic acid modified LDH samples obtained from both (first and second) methods provide magnesium salts of cis-1,2-cyclohexanedicarboxylic acid. It is noted that the decrease in FIG. 5 at 200° C. of the Mg—cis-1,2-cyclohexanedicarboxylic acid curve is caused by unreacted cis-1,2-cyclohexanedicarboxylic acid.

It is noted that the bottom line of FIG. 5 at 400° C. refers to cis-1,2-cyclohexanedicarboxylic acid and the top line at 400° C. refers to cis-1,2-cyclohexanedicarboxylic acid magnesium salt.

Furthermore, the XRD pattern of both cis-1,2-cyclohexanedicarboxylic acid modified LDH and bicyclo[2.2.1]heptane-2,3-dicarboxylic acid modified LDH show a new crystal configuration introduced at range 5.9 2Theta to 7.9 2Theta for cis-1,2-cyclohexanedicarboxylic acid synthesized using the first method and 6.8 2Theta for the second method (see FIG. 6). FIG. 6 also shows a new crystal formed at the LDH treated with bicyclo[2.2.1]heptane-2,3-dicarboxylic acid at 8.3 2Theta, but only for the second method and not for the first method. Besides the small decrease of the carbonate visible at peak (003) and (006) no significant changes have been observed within the crystallographic structure of the LDH samples. This decrease of carbonate is caused by a side effect of the reaction with the organic acids cis-1,2-cyclohexanedicarboxylic acid or bicyclo[2.2.1]heptane-2,3-dicarboxylic acid at both methods.

It is noted that in FIG. 6 line A refers to untreated LDH, line B refers to cis-1,2-cyclohexanedicarboxylic acid modified LDH synthesized using the first method, line C refers to cis-1,2-cyclohexanedicarboxylic acid modified LDH synthesized using the second method, line D refers to bicyclo[2.2.1]heptane-2,3-dicarboxylic acid modified LDH synthesized using the first method, and line E refers to bicyclo[2.2.1]heptane-2,3-dicarboxylic acid modified LDH synthesized using the second method.

Since Mg—cis-1,2-cyclohexanedicarboxylic acid has been observed in both cis-1,2-cyclohexanedicarboxylic acid modified LDH samples, an experiment is dedicated to treat the surface of the LDH with Mg—cis-1,2-cyclohexanedicarboxylic acid instead of cis-1,2-cyclohexanedicarboxylic acid. This experiment is performed according to the second method, where the cis-1,2-cyclohexanedicarboxylic acid is replaced by Mg—cis-1,2-cyclohexanedicarboxylic acid. It was found that a material without Mg—cis-1,2-cyclohexanedicarboxylic acid crystals on the surface as can be seen in the XRD pattern “B” of FIG. 7. The absence of the peak at 6.8 2Theta confirms that the reaction must be performed with cis-1,2-cyclohexanedicarboxylic acid to synthesize a LDH surface with Mg—cis-1,2-cyclohexanedicarboxylic acid salt crystals.

It is noted that in FIG. 7 line A refers to modified LDH according to the second method, and line B refers to modified LDH according to the second method wherein cis-1,2-cyclohexanedicarboxylic acid is replaced with Mg—cis-1,2-cyclohexanedicarboxylic acid.

The spectra of the FT-IR as can be seen in FIG. 8 shows the presence of peaks at 1480 cm¹, 1550 cm⁻¹, 1600 cm⁻¹, 1690 cm⁻¹ and the peaks within the range of 2850 cm⁻¹ to 2975 cm⁻¹. To start with the range of 2850 cm⁻¹ to 2975 cm⁻¹ which correlates to the asymmetric and symmetric C—H stretches of cis-1,2-cyclohexanedicarboxylic acid and bicyclo[2.2.1]heptane-2,3-dicarboxylic acid. 1690 cm⁻¹ correlated with the amount of water within the interlayer of the LDH. 1600 cm⁻¹ and 1550 cm⁻¹ are the peaks of the carboxylate groups of the cis-1,2-cyclohexanedicarboxylic acid and bicyclo[2.2.1]heptane-2,3-dicarboxylic acid. The 1480 cm⁻¹ peaks are the vibration of the alkene hydrogens. The presence of those peaks indicates that cis-1,2-cyclohexanedicarboxylic acid and bicyclo[2.2.1]heptane-2,3-dicarboxylic acid have reacted with the LDH to form carboxylate groups instead of carboxylic acid groups, which should have peaks at 1720 cm⁻¹ to 1706 cm⁻¹ and 1440 to 1395 cm⁻¹. Furthermore, it seems that material made according to the first method has the preference to form the carboxylate at 1550 cm⁻¹, where material according to the second method show more preference to the carboxylate at 1600 cm⁻¹.

It is noted that in FIG. 8 line A refers to untreated LDH, line B refers to cis-1,2-cyclohexanedicarboxylic acid modified LDH synthesized using the first method, line C refers to cis-1,2-cyclohexanedicarboxylic acid modified LDH synthesized using the second method, line D refers to bicyclo[2.2.1]heptane-2,3-dicarboxylic acid modified LDH synthesized using the first method, and line E refers to bicyclo[2.2.1]heptane-2,3-dicarboxylic acid modified LDH synthesized using the second method.

FIG. 9 shows the SEM images of the surface treated material versus the untreated material. Picture A shows the untreated sample and has no additional crystals attached to the surface. Picture B is cis-1,2-cyclohexanedicarboxylic acid modified LDH synthesized according to the first method and shows a little amount of crystals on the surface of the LDH. cis-1,2-cyclohexanedicarboxylic acid modified LDH synthesized according to the second method shows more crystals, which could also be expected based on the XRD pattern. Furthermore, unlike cis-1,2-cyclohexanedicarboxylic acid, bicyclo[2.2.1]heptane-2,3-dicarboxylic acid does not show any crystals after treated according to the first method but does have crystals on the surface after treated according to the second method. In addition, the XRD pattern of bicyclo[2.2.1]heptane-2,3-dicarboxylic acid shows newly formed crystals by the second method. These crystals cannot be observed in the XRD spectrum of the first method. The combination of SEM and XRD confirms that the surface of the LDH is modified by magnesium salt crystals of cis-1,2-cyclohexanedicarboxylic acid and bicyclo[2.2.1]heptane-2,3-dicarboxylic acid instead of being a mixture of the salt and LDH.

Thus, it can be concluded that cis-1,2-cyclohexanedicarboxylic acid modified LDH as well as bicyclo[2.2.1]heptane-2,3-dicarboxylic acid modified LDH were successfully synthesized, wherein the surface of the LDH was modified with an acid.

In a further experiment, the nucleation behaviour of the (surface) modified LDH according to the invention is shown. The tested LDH was cis-1,2-cyclohexanedicarboxylic acid modified LDH according to the invention. Said particles were synthesized using the second method of the previous described experiment. The results are shown in Table 6.

TABLE 6
Results nucleation behaviour.

| | | | Reaction | | |
|---|---|---|---|---|---|
| | | | temperature | | Tc |
| Entry | LDH | Agitation | (° C.) | Dried | (° C.) |
| A | Slurry | Overhead | 80 | Static | 125.7 |
| B | Slurry | Magnetic | 80 | Static | 126.1 |
| C | Powder | Overhead | 80 | Static | 125.5 |
| D | Powder | Magnetic | 80 | Static | 125.8 |
| E | Slurry | Overhead | 60 | Static | 123.4 |
| F | Powder | Magnetic | 20 | Static | 122.7 |
| G | Powder | Overhead | 20 | Static | 121.9 |
| H | Slurry | Overhead | 80 | Static | 126.8 |
| I | Slurry | Overhead | 80 | Spray | 127.8 |
| J | Slurry | Overhead | 20 | Static | 120.4 |

The most significant difference of the Tc is caused by the change of temperature. A small increase of approximated 2° C. in Tc was observed for samples created at 20° C. compared to LDH-free PP, which has a Tc of around 120° C. This already increased by an additional of 1° C. when the temperature increases to 60° C. during the reaction, and an approximated 7° C. increase once the reaction was performed at 80° C.

Furthermore, powder or slurry of starting LDH does not have a significant effect on the Tc and neither does the agitation have a significant effect. Spray drying has an increased effect on the Tc compared to samples which have been dried in a static oven.

FIG. 10 shows the XRD patterns of the samples mentioned in Table 6. Notable is that the peak at 6.8 2Theta, which indicates Mg—cis-1,2-cyclohexanedicarboxylic acid, is better defined for samples which show higher Tc and is less or not even present for samples which show a little to no increase in Tc. This indicates that a well-defined peak at 6.8 2Theta results in a higher Tc.

FIG. 11 shows the FT-IR spectra of the samples mentioned in Table 6. The peaks at 1550 cm⁻¹ and 1600 cm⁻¹ are Mg—cis-1,2-cyclohexanedicarboxylic acid on the surface of the LDH. The same observation is made for the XRD, a higher Tc shows a well-defined peak at especially 1600 cm⁻¹. Sample H and I have sharp peaks and have the highest Tc compared to the other samples. Sample F for example has a smaller peak at 1600 cm⁻¹ but (a slightly) larger peak at 1550 cm⁻¹. But although the 1550 cm⁻¹ peak is larger, this did not result in a higher Tc. Therefore, it could be concluded that especially the peak at 1600 cm⁻¹ provides an indication of the nucleation effect of the material.

Thus, it can be concluded that the modified LDH according to the invention has a nucleation effect.

In a further experiment, modified LDH particles were synthesized and analysed using wide-angle X-ray diffraction (WAXD).

WAXD is used for the effect of the various LDH particles according to the invention in the synthesis of polymers such as polypropylene, and if said particles comprises of a and/or 0 nucleator. It is noted that a nucleator form/are monoclinic (square) crystals and p nucleation form/are hexagonal crystals.

The WAXD analysis of the polypropylene comprising LDHs according to the invention were performed using a Panalytical X-pert powder spectrometer with PIXcal1D-Medipix3 collaboration RTMS detector using the scanning line detector. For these measurements Cu Kα radiation (λ=1.54 Å) was used. The step size of the goniometer was 0.0262610 2Theta at a counting time of 7.14 s, scan range 5.000 to 69.9949 with no. of point 2475. The spectra were recorded at 45 kV and 40 mA. Focus length 12.0 mm, width 0.4 mm and take-off angle of 6.0°. Beta-filter Nickel with a thickness of 0.020 mm. Soller slit 0.02 rad. Fixed incident beam mask 15 mm, width 11.60 mm. Anti-scatter slit Fixed slit ½°, with a height of 0.76 mm. Divergence slit Fixed slit ¼° with height 0.38 mm.

Table 7 shows the various LDH particles according to the invention.

TABLE 7
List of molecules tested and reacted with LDH.

| | | Tc average |
|---|---|---|
| Acid | Code | (° C.) |
| none | N/A | ±120 |
| DHT ™-4V | N/A | 119.85 |
| benzoic acid | Benzoic | 120.05 |
| cis-1,2-cyclohexanedicarboxylic acid | HHPA | 125.35 |
| 2,6-naphthalene dicarboxylic acid | NAP | 122.50 |
| bicyclo[2.2.1]heptane-2,3-dicarboxylic acid (2,3- | NOR | 126.20 |
| norbornanedicarboxylic acid) | | |
| pimelic acid | PIM | 123.50 |
| phenylphosphonic acid | PPA | 125.75 |
| benzene-1,3,5-tricarboxylic acid (trimesic acid) | TRI | 121.90 |
| 1,3,5-triazine-2,4,6-triol (cyanuric acid) | CYAN | 121.35 |
| 4-amino benzoic acid | PABA | 121.20 |
| 1,4-cyclohexane dicarboxylic acid | CDA | 121.85 |
| 2-carboxyethyl (phenyl) phosphinic acid | CEPPA | 120.65 |
| 4-propyl cyclohexane carboxylic acid | PCCA | 120.85 |
| butylphosphonic acid | BPA | 120.20 |
| 4-toluenesulfonic acid | TSA | 120.10 |

It is noted that DHT ™-4V is a hydrotalcite used as acid scavenger in conventional synthesis of polypropylene.

FIG. 12 shows the XRD pattern of seven molecules with nucleation effect. All patterns except pimelic acid and 1,4-cyclohexane dicarboxylic acid show a newly introduced crystal, which also has been observed for cis-1,2-cyclohexanedicarboxylic acid modified LDH. No peak repeats appear of the 003, 006 and 009 besides the carbonate, which is intercalated in the LDH particles. Therefore, it can be concluded that none of the molecules have been intercalated.

Furthermore, it was found that pimelic acid and 1,4-cyclohexane dicarboxylic acid show nucleation effect. Expected is that the LDH is coated with an organic layer of pimelic acid or 1,4-cyclohexane dicarboxylic acid instead of covered with Mg-crystals since the FT-IR spectra F and H in FIG. 13 show the presence of an organic molecule. In addition, said FT-IR spectra show the presence of the carboxylate group at 1550 cm⁻¹ or 1600 cm⁻¹, except for A and D which are the untreated and PPA treated material (PPA is a phosphonic acid derivate and refers to phenyl phosphonic acid) wherein the phosphate peak is at about 1150 cm⁻¹ (see FIG. 13).

Table 8 shows the results of the PSD, BET, concentration of the molecule on the surface of the LDH and the acid scavenging functionality of the materials. No significant changes occur regarding the PSD after been modified with organic acids. The BET increased of all materials after been modified with the organic acids, which indicates that the surface has been modified because of the reaction. The remaining amount of organic acid or derivative on the surface of the LDH according to the invention as can be seen in Table 8 and is in many cases lower than the 10% initial added to the reaction. This indicates that not all organic acid is used during the reaction or that not all organic acid or derivative is attached to the surface. For phenylphosphonic acid and the benzene-1,3,5-tricarboxylic acid it was found that the surface treatment reaction is substantially completed.

Furthermore, the nucleation effect of the LDH particles according to the invention as well as the acid scavenging functionality of the was preserved. The acid scavenging titration resulted in a decrease of functionality once modified with the organic acid from 2.4 mol chloride per mol LDH to 1.86 mol chloride per mol LDH. It was found that the LDH particles according to the invention can scavenge at least 1.86 mol chloride per mol LDH and therefore have acid scavenging functionality. Compared to the commercial available DHT™-4V, which is widely used as acid scavenger, the modified LDH particles according to the invention lose at most 15% of their acid scavenging functionality in exchange of having a nucleation effect as well.

TABLE 8
Overview specifications of the modified LDH.

| | | | | | | | | | Acid |
|---|---|---|---|---|---|---|---|---|---|
| | PSD | PSD | PSD | | | Specific | Specific | Concentration | scavenging |
| | D50 | <1 μm | >5 μm | Ratio | BET | XRD peak | FTIR peak | of molecule | (mol Cl⁻/ |
| Sample | (μm) | (%) | (%) | (Mg/Al₂O₃) | (g m⁻²) | (2Theta) | (cm − 1) | (%) | mol LDH) |
| Untreated | 0.431 | 94.21 | 0 | 4.324 | 14.88 | none | None | N/A | 2.43 |
| DHT ™-4V | 0.405 | 89.32 | 2.88 | 4.303 | 10.99 | N/A | N/A | N/A | 2.16 |
| cis-1,2- | 0.368 | 97.14 | 0 | 4.135 | 22.02 | 6.8 | 1600 | 4.59 | 1.91 |
| cyclohexanedicarboxylic | | | | | | | | | |
| acid | | | | | | | | | |
| NOR | 0.369 | 96.54 | 0 | 4.147 | 19.12 | 8.1 | 1600/ | 4.11 | 1.86 |
| | | | | | | | 1700 | | |
| PPA | 0.371 | 96.68 | 0 | 4.260 | 26.11 | 6.1 | 1110/ | 9.46 | 2.10 |
| | | | | | | | 1155 | | |
| NAP | 0.396 | 92.71 | 2.72 | 4.225 | 16.31 | 7.8 | 1560/ | 7.65 | 1.92 |
| | | | | | | | 1600 | | |
| PIM | 0.365 | 97.17 | 0 | 4.123 | 16.75 | None | 1560 | >1.66* | 2.10 |
| TRI | 0.389 | 96.96 | 0 | 4.110 | 15.46 | 7.7 | 1560/ | 8.6 | 1.89 |
| | | | | | | | 1615 | | |
| CDA | 0.388 | 96.03 | 0 | 4.167 | 19.38 | None | 1590 | 3.82 | 2.20 |

*The concentration PIM decreases overtime, what have been tested with an overnight analysis. Therefore it is expected that the real concentration of PIM is above the measured value.

The WAXD pattern of the cis-1,2-cyclohexanedicarboxylic acid modified LDH and bicyclo[2.2.1]heptane-2,3-dicarboxylic acid modified LDH is shown in FIG. 14. This analysis show that the polypropylene without LDH contains a little β-nucleation and mostly α-nucleation. Adding cis-1,2-cyclohexanedicarboxylic acid modified LDH to the polypropylene the β-nucleation decreased and the α-nucleation increased and therefore cis-1,2-cyclohexanedicarboxylic acid modified LDH could be considered as α-nucleator. The bicyclo[2.2.1]heptane-2,3-dicarboxylic acid modified LDH additive decreases the β-nucleation even more but increases the α-nucleation, like cis-1,2-cyclohexanedicarboxylic acid did as well. Therefore also bicyclo[2.2.1]heptane-2,3-dicarboxylic acid modified LDH could be considered as α-nucleator.

It was found that an increase of at least 1.5° C. of the Tc of polypropylene including the modified LDH according to the invention compared to the Tc of polypropylene including untreated LDH was achieved. In addition, it was found that said modified LDH according to the invention has an acid scavenging and nucleation effect. In a further experiment, LDH particles with different specifications were used. The modified LDH particles were synthesized according to the method disclosed before. In said method, the LDH particles were synthesised with zinc, different ratio magnesium to aluminium, BET and PSD or aspect ratio.

The specific surface area of the samples was determined using a Quantachrome Monosorb Surface Area Analyser. The samples are prepared by degassing them at 90° C. for 15 minutes under He/N₂ (30/70) flow. After degassing the sample holder is immersed in liquid nitrogen for several minutes. Subsequently, the sample holder is heated to room temperature by an on-board heater. The amount of desorbed He/N₂ is measured by a thermal conductivity detector and the intensity of the signal is converted to the specific surface area by mass (in unit of m² g⁻¹) of the sample.

Furthermore, the particle size distribution (PSD) is determined using a Microtrac S3500. Said samples were dispersed in ultra-pure water and methanol and homogenized by sonification with the Cole Palmer for 5 minutes at 38% amplitude before approximated 1 mL is added in the sample chamber.

The LDH particles with different specifications were reacted with cis-1,2-cyclohexanedicarboxylic acid. The DSC of various samples is provided in Table 9.

TABLE 9
Overview results.

| | | PSD | | | DSC |
|---|---|---|---|---|---|
| | BET | d50 | <1 μm | >5 μm | Tc |
| Sample | g m⁻² | (μm) | (%) | (%) | (° C.) |
| Retention | 17.63 | 0.528 | 91.91 | 0 | 126.1 |
| ZnMgAl LDH | 16.36 | 0.538 | 93.19 | 0 | 125.6 |
| MgO/Al₂O₃ = 6 | 19.77 | 0.370 | 97.06 | 2.02 | 125.7 |
| High BET/Low PSD | 38.07 | 0.219 | 94.79 | 3.63 | 128.6 |
| High PSD/Low BET | 14.49 | 0.738 | 82.82 | 0 | 126.7 |
| Aspect ratio 10.2 | 21.12 | 0.669 | 76 | 0 | 127.1 |

It can be concluded that the abovementioned modified LDH particles show nucleation effect as well as acid scavenging properties, of which the modified LDH particles with high BET and low PSD sample showed improved nucleation effect.

Furthermore, it can be concluded that the modified LDH particles according to the invention provide an efficient and effective nucleation effect and acid scavenging functionalities.

The present invention is by no means limited to the above-described preferred embodiments and/or experiments thereof. The rights sought are defined by the following claims within the scope of which many modifications can be envisaged.

1. Modified layered double hydroxide (LDH) according to formula (I):
[[[M₁²⁺]_{y}(M₂²⁺)_{z}]₁₋ₓ[M₃³⁺]ₓ(OH)₂](Aⁿ⁻)_{x/n}·mH2O (I)
wherein M₁ and M₂ are each independently a divalent metal selected from the group of Mg, Zn, Ca, Sr, Cu, Fe, Mn, Co, Ni, Sn, Pb, Cd, and Ba,
wherein M₃ is a trivalent metal,
wherein Aⁿ⁻ is one or more of an intercalating n-valent anion,
wherein m, x, y, and z are values in the ranges represented by 0≤m<2, 0<x≤0.5, and 0.5≤y+z≤1,
wherein the modified LDH comprises a modified outer layer, wherein the outer layer is modified with an organic acid or salts thereof,
wherein the organic acid or salts thereof is one or more selected from di-carboxy-C₁₋₁₂ alkyl, bis C₁₋₁₂ alkyl phosphonate, N-substituted isocyanurate, mono-, di, tri-carboxy-C₃₋₈ cycloalkane, or an organic acid according to formula (II): 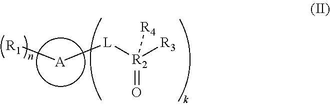
wherein k is an integer from 1 to 3,
wherein n is an integer from 0 to 5,
wherein A represents a cycloalkyl, aryl, or heteroaryl,
wherein L represents a direct bond or NH,
wherein R₁ is one or more independently selected from hydroxy, carboxyl, C₁₋₆ alkoxycarbonyl, arylcarbonylamino, amino, amide, C₁₋₆ alkyl, hydroxy phosphoryl, Het, or Ar,
wherein Ar represents an aryl,
wherein Het represents heterocycle,
wherein R₂ represents C or P or S,
wherein R₃ is hydroxy and present when L represents a direct bond, or wherein R₃ is hydroxy or C₁₋₆ alkyl when L represents NH, and
wherein R₄ is hydroxy or C₁₋₆ alkylcarbonyl and present when R₂ represents P, or wherein R₄ is a doubled bonded oxygen and present when R₂ represents S.

2. The modified LDH according to claim 1, wherein formula II is represented by formula III,

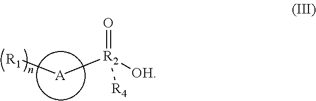

3. The modified LDH according to claim 1, wherein A is independently selected from an aryl or heteroaryl.

4. The modified LDH according to claim 1, wherein the organic acid or salts thereof is one or more selected from the group of bicyclo[2.2.1]heptane-2,3-dicarboxylic acid, cis-1,2-cyclohexanedicarboxylic acid, (1R, 2S)-2-methoxycarbonyl cyclohexane carboxylic acid, 1,3,5-tris(2,2-dimethylpropionylamino)benzene, 2,6-naphthalene dicarboxylic acid, benzoic acid, pimelic acid, phenylphosphonic acid, 2,6-dihydroxypyrimidine-4-carboxylic acid, 4-pyridinecarboxylic acid, benzene-1,3,5-tricarboxylic acid, 4-(benzoylamino)benzoic acid, disodium malonate, sodium acetate, 2,3-pyridinedicarboxylic acid, 2-carboxyethyl (phenyl) phosphinic acid, 2-naphthalenecarboxylic acid, 2-tert-butylbenzoic acid, 4-amino benzoic acid, 4-biphenyl carboxylic acid, 4-toluenesulfonic acid, bis(2-ethylhexyl)hydrogen phosphate, 4-phthalimidobenzoic acid, 4-tert-butylbenzoic acid.

5. The modified LDH according to claim 1, wherein the organic acid or salts thereof is one or more selected from the group of bicyclo[2.2.1]heptane-2,3-dicarboxylic acid, cis-1,2-cyclohexanedicarboxylic acid, pimelic acid, phenylphosphonic acid, 2,6-naphthalene dicarboxylic acid.

6. The modified LDH according to claim 1, wherein the organic acid or salts thereof is cis-1,2-cyclohexanedicarboxylic acid.

7. The modified LDH according to claim 6, wherein the modified LDH comprises an X-ray diffraction peak in the range of 4° 2Theta to 9° 2Theta.

8. The modified LDH according to claim 1, wherein the organic acid or salts thereof comprises 1,3,5-triazine-2,4,6-triol.

9. The modified LDH according to claim 1, wherein the organic acid or salts thereof comprises a mono-, di-, or tri-carboxy cyclohexane, preferably wherein the mono-, di-, or tri-carboxy cyclohexane is 1,4-cyclohexanedicarboxylic acid and/or 4-propyl cyclohexane carboxylic acid.

10. The modified LDH according to claim 1, wherein Aⁿ⁻ is one or more selected from the group of a carbonate ion, nitrate ion, sulphate ion, or combinations thereof.

11. The modified LDH according to claim 1, wherein Aⁿ⁻ is a carbonate ion.

12. Particles comprising the modified LDH according to claim 1.

13. Particles according to claim 12, having an average secondary particle diameter measured by a laser diffraction method in the range of 0.01 μm to 20 μm.

14. Resin composition comprising a resin and particles according to claim 12 in the range of 1 ppm to 10000 ppm.

15. Resin composition according to claim 14, wherein the resin is one or more selected from the group of a polyolefin, a polyvinyl chloride, a poly vinyl alcohol, a poly lactic acid.

16-26. (canceled)
